(19) United States
(12) Patent Application Publication
(10) Pub. No.: US 2011/0239399 A1
(43) Pub. Date: Oct. 6, 2011

(54) Vacuum Cleaner and Filter Bag Insert for a Vacuum Cleaner

(75) Inventor: Christopher Robert Duncan, Chard (GB)

(73) Assignee: NUMATIC INTERNATIONAL LIMITED, Camberley, Surrey (GB)

(21) Appl. No.: 13/133,169

(22) PCT Filed: Dec. 7, 2009
(86) PCT No.: PCT/GB2009/002831

§ 371 Date: Jun. 24, 2011

(30) Foreign Application Priority Data
Dec. 8, 2008 (GB) 0822365.3
Mar. 5, 2009 (GB) 0903827.4

(51) Int. Cl. A47L 9/10; B23P 17/04; B01D 46/02

(52) U.S. Cl. 15/347; 29/401.1; 55/378

(57) ABSTRACT

The present invention relates to the field of vacuum cleaners and relates in particular to domestic or commercial cleaners which are provided with a bin (or vacuum chamber), rather than a filter bag, to collect air-entrained detritus. According to one aspect of the invention there is provided an insert (20,100) for converting a vacuum cleaner (10) of the aforementioned type so as to make the cleaner capable of operating in a mode in which air-entrained detritus is collected in a filter bag (29,109) located in the vacuum chamber (27), the insert comprising an enclosure (20,21,22,38,100,101) in which the filter bag may be accommodated, which enclosure comprises structural constraint means (21,22,23,24,38,103) which limits vacuum induced expansion of at least a region of the bag and maintains an airflow gap (28,108) between the filter bag outer surface and a vacuum chamber inner wall. The constraint means may in one embodiment be a plurality of inward facing spacer ribs (103). In another the constraint means may be a perforated drum (21).

The present invention relates to the field of vacuum cleaners and in particular domestic or commercial cleaners in which an operator directs the cleaner over a floor or carpet surface to effect cleaning. The invention also concerns cleaners used to collect fine dust thrown up by grinding and chasing into brickwork and plasterwork in the building trade.

Typical vacuum cleaners for cleaning domestic or office spaces come in two general forms; upright type cleaners or drum and wand type cleaner. Upright cleaners have a work head which typically includes rollers and a driven roller brush for lifting detritus from a floor surface, connected via an articulated joint to a generally vertical handle portion. The handle portion carries an elongate vertically oriented filter bag for receiving air entrained detritus from the floor surface.

Drum and wand type cleaners have a wheeled drum unit which includes a bin chamber provided at an upper end thereof with a vacuum filter upstream of a vacuum drive motor. The wand typically comprises a rigid elongate tubular handle portion which may carry at a distal end a work head equipped with a cleaning or brushing tool. The tube is connected to the drum unit by a flexible tubular vacuum tube, which communicates with the interior of the bin chamber. In a typical arrangement the filter is a baffle over an air inlet to a vacuum drive motor located at a top end of the bin. The detritus is deposited in a lower portion of the bin.

In some applications it is important to collect and dispose of air entrained fine dust without risk of the dust being released into the air after collection and when emptying the bin chamber into a secondary refuse sack. This applies for example to fine dust collected from grinding of brick work or plaster in building construction. The fine dust can be harmful when inhaled and is easily released into the atmosphere, dirtying a building's interior. Thus drum and wand type cleaners are available in which a collection bag is placed in the bin chamber so that the bag may be sealed and disposed of after use rather than requiring emptying of the bin chamber into a secondary collection vessel.

In a particular arrangement the collection bag is a filter bag through which air is drawn to collect air entrained dust in bag. The bag is sized to correspond with the dimensions of the bin chamber, although of slightly reduced size so as to provide an air gap around the bag which communicates with the vacuum source.

Upright and drum/wand cleaners may have different precise configurations and the foregoing description of typical configurations is not intended to limit the present invention to a particular type of cleaner. The present invention does however apply in particular to drum and wand type cleaners equipped with a filter bag. The invention may also be used in upright cleaners or any cleaner which uses a filter bag for collection of air entrained detritus.

A problem with known vacuum cleaners which include a filter bag for collecting air entrained detritus is that the filter bag may reduce vacuum cleaner performance during use. For example the filter pores may become blocked over time, reducing suction performance. A less well appreciated problem is that of expansion of the bag under vacuum loading. This may cause the bag surface to abut a bag chamber wall, thereby restricting free airflow through the bag and to the vacuum source.

U.S. Pat. No. 5,681,363 discloses a vacuum cleaner filter shaker which dislodges dirt from a filter membrane. The filter membrane is cup-shaped and sits in a support frame which is flexible. The frame allows the cup to expand under vacuum loading and contract after loading. This flexing dislodges dirt and helps keep the filter membrane clean.

U.S. Pat. No. 5,564,155 discloses a drum and wand type cleaner in which a disposable plastic collection bag is located in a bin chamber for collecting fine dust. An internal flexible coil sleeve is placed in the bag and prevents the bag collapsing under vacuum loading. This invention does not concern vacuum cleaners having an air-permeable filter bag for collecting dust/detritus and its collection bag is a simple disposable plastic bag.

CA-A-2609878 discloses a support cage of a filter in a “wet and dry” drum type vacuum cleaner. The cage is made up of a series of vertically spaced oval hoops held in position by longitudinal stringers. The cage acts to prevent internal collapse of the filter onto a float valve mechanism. This is not an example of a filter bag which is used to collect dust and air-entrained matter. The filter simply excludes solids and liquids from exiting to the drive fan. A filter cage arrangement for another drum type wet/dry vacuum cleaner is shown in U.S. Pat. No. 4,185,974.

In an upright vacuum cleaner US-A-2007/0022565 discloses a bag cage which provided external support for a dust collection filter bag. The cage is also stated to be suitable for use in canister type cleaners. The cage is a rectilinear frame with a detachable side which permits unloading of the bag from the cage interior.

US2005/0132676 discloses a disposable open-ended vacuum cleaner sack for use in collecting detritus in a drum type vacuum cleaner. However the bag is not a filter bag and the suction source does not draw air through the bag. Hence expansion of the bag under vacuum pressure is not a problem.

U.S. Pat. No. 5,946,768 discloses a vacuum cleaner having a porous filter bag. This has a typical prior art arrangement in which expansion of the filter bag under vacuum loading will tend to cause the bag to become occluded against the interior wall of the vacuum chamber.

JP 2006223431 discloses a vacuum cleaner in which a collection bag is disposed in a basket with a handle, which basket limits swelling of the collection bag under loading so as to prevent the bag tearing along a weak joint.

A further issue in vacuum cleaners relates to cleaners of a type in which dust/detritus is collected in a vacuum chamber (or bin) rather than a filter bag. These cleaners are commonly used for wet/dry cleaning where a paper filter bag would be impracticable, or for demanding professional cleaning roles where repeated emptying of bags is to be avoided on grounds of cost and productivity.

These machines, such as Numatic International's Henry™ product, typically have a suction motor which is isolated from the detritus laden vacuum chamber by a porous filter surface. In several industrial applications it would however be useful to be able to collect dust without risk of subsequent contamination of the atmosphere with the dust during disposal of the cleaner contents. This is particularly so in the collection of fine brick or plaster dust during grinding or machining—for example chasing of cables into building walls. This also applies to the collection of harmful materials such as dust which may be explosive when airborne, or which may be harmful to humans if released into the air. In these circumstances it would be useful to be able to isolate the collected detritus in a bag or other container so that it is isolated from the atmosphere.

It is one object of the invention to provide a vacuum cleaner which may be configured to operate in a bag collection mode or in a bin collection mode according to requirements.

It is another object to provide a way of converting known bin collecting vacuum cleaners so that they may be used to collect detritus in a bag for safe disposal.

It is yet another object of the present invention to provide a solution to the problem of maintaining filter bag performance during use so as to ensure that vacuum cleaner suction loss is reduced.

One or more of these objects is met by the subject matter of the claims hereinafter.

According one aspect of the present invention there is provided an insert for converting a vacuum cleaner of a type which is configured to operate in a first mode in which air-entrained detritus can be deposited and collected in a vacuum chamber rather than collected in a filter bag through which air is drawn, to a second operative mode in which air-entrained detritus is collected in a filter bag located in the vacuum chamber, the insert comprising an enclosure in which the filter bag may be accommodated, which enclosure comprises structural constraint means which limits vacuum induced expansion of at least a region of the bag and maintains an airflow gap between the filter bag outer surface and a vacuum chamber inner wall.

The structural constraint means may comprise a plurality of spaced apart protrusions provided in a base sheet, each protrusion having a base region and a distal end which faces a surface region of the filter bag to limit expansion thereof.

The protrusions may comprise elongate ribs each having a longitudinal axis which extends parallel to a bag outer surface region and a transverse elongate distal edge which faces the surface region of the bag to limit expansion thereof.

The ribs may be are oriented generally parallel to each other and define therebetween airflow channels for air drawn through the bag surface and towards a vacuum source.

For machines having cylindrical vacuum chambers the enclosure base sheet is preferably generally cylindrical in shape. The distal ends or edges of the protrusions thus project from the inner surface of the base sheet.

The protrusions are in a preferred embodiment a plurality of axially oriented elongate parallel ribs which provide airflow channels in a direction parallel to the cylindrical axis.

In another aspect of the invention, the enclosure comprises a web of material having an inner surface which faces an outer surface region of the filter bag and which limits expansion thereof, and an outer surface which faces the vacuum chamber wall, the web being provided with a plurality of perforations therethrough which provide an airflow path through the enclosure. In this arrangement the filter bag expands to contact the web, with the perforations providing a flow path through the web.

The web outer surface may be provided with a plurality of protrusions which maintain a spacing between the enclosure outer surface and the vacuum chamber inner wall.

The enclosure web may be generally cylindrical in shape so as to match the shape of the vacuum chamber in a cylindrical bin cleaner.

The enclosure may further comprise a detachable lid plate which provides access to the enclosure interior for placement and removal of a filter bag.

The outer surface protrusions may comprise a plurality of elongate axially extending spacer ribs which serve to space the enclosure wall from the vacuum chamber so as to maintain an airflow gap between the outer surface and the chamber inner wall.

The enclosure may be formed from perforated sheet or mesh sheet or lattice work material which remains rigid under vacuum induced bag loading. The web preferably comprises perforated sheet material, with the area of the perforations being preferably at least 40% of the web area, and most preferably at least 50% of the web area.

A wall portion of the enclosure is typically formed with an aperture through which a vacuum tube may extend for delivery of air entrained detritus into a filter bag disposed in the enclosure.

According to a further aspect of the invention, there is provided a vacuum cleaner comprising a vacuum source in fluid communication with a vacuum chamber in which is disposed a filter bag for collecting detritus, the vacuum source being arranged, in use, to draw detritus-laden air into the bag, wherein an insert as hereinbefore described is disposed in the vacuum chamber, with the filter bag accommodated in the insert which limits vacuum induced expansion of the bag in one or more directions so that a minimum spacing between a surface portion of the bag and a wall portion of the vacuum chamber bag is maintained, the spacing providing an air gap through which air may be drawn towards the vacuum source, and wherein the minimum spacing would be reduced in the absence of the restraint means due to expansion of the bag.

The vacuum chamber may have a cylindrical shape.

The insert may be centrally disposed in the vacuum chamber.

The filter bag may be generally drum shaped and formed with an inlet aperture which aligns with an aperture in the enclosure. A vacuum duct may pass through both apertures to discharge detritus in the bag.

The vacuum cleaner may be of a type having a vacuum wand portion, the wand portion being provided with a distal end region for lifting detritus from a surface to be cleaned and a fluid flow path for conveying detritus to the vacuum chamber. The cleaner may have a lower portion which comprises a vacuum chamber and an upper portion in which is located a suction motor for drawing air into the vacuum chamber via the wand portion.

The upper portion may be detachable from, or may be flipped with respect to, the collection bin so as to facilitate emptying of the bin.

The insert is, in yet another aspect of the invention, removeable from the vacuum chamber. The insert should be a size and configuration which provides a sliding fit in the vacuum chamber.

In a yet further aspect of the invention there is provided a method of converting a vacuum cleaner of a type which is configured to operate in a first mode in which air-entrained detritus can be deposited and collected in a vacuum chamber rather than collected in a filter bag through which air is drawn, to a second operative mode in which air-entrained detritus is collected in a filter bag located in the vacuum chamber, the method comprising providing an insert as hereinbefore described, the method comprising opening the vacuum chamber, placing the insert in the vacuum chamber and locating a filter bag in the enclosure provided by the insert.

Following is a description by way of example only, and with reference to the figures, of two preferred modes for putting the present invention into effect.

In the drawings:

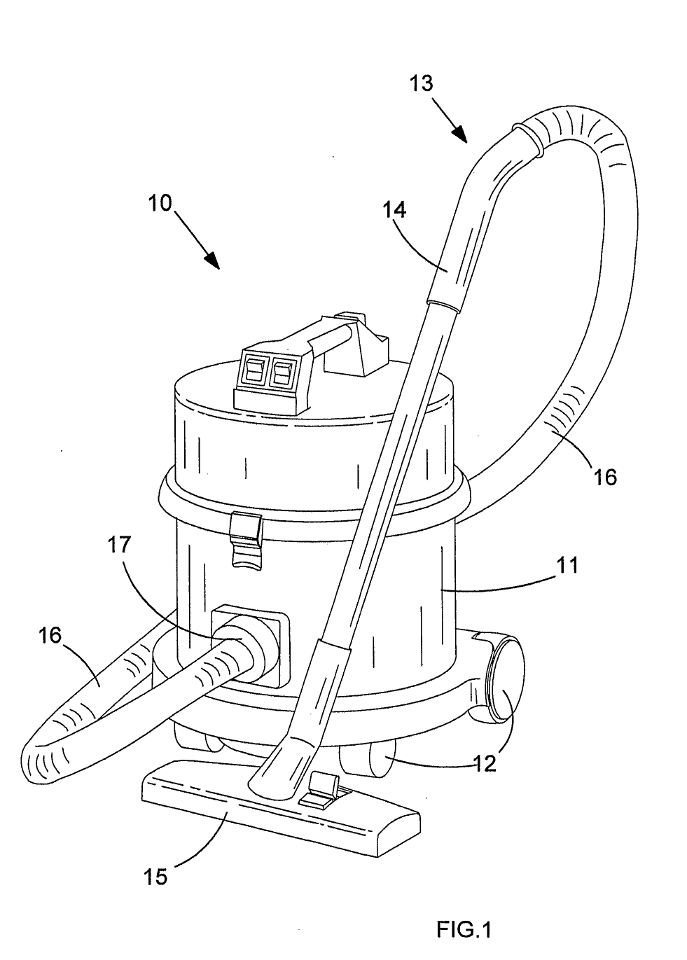

FIG. 1 is a perspective three quarter view of a wand and bin type vacuum cleaner according to a first embodiment of the present invention.

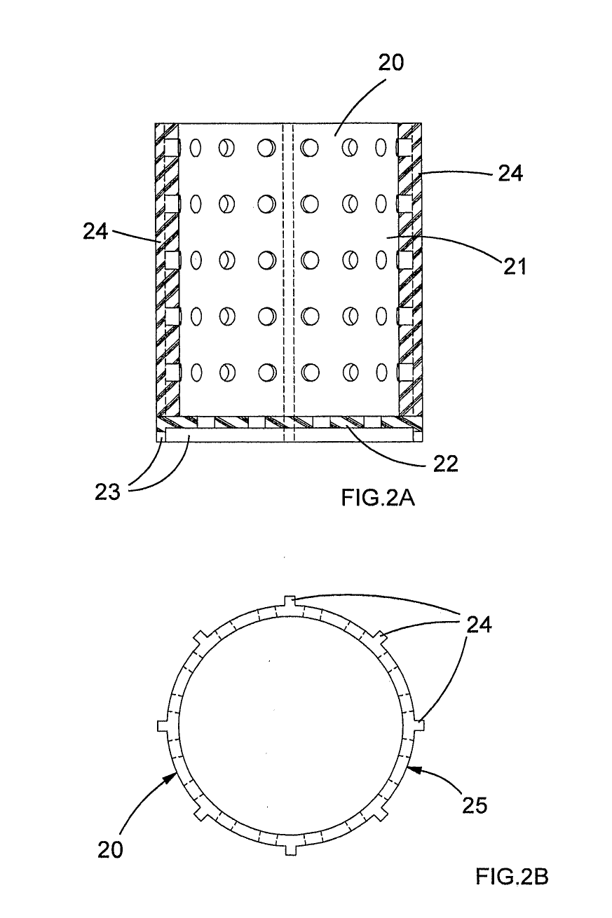

FIG. 2A is a side view of a sectioned vacuum chamber insert for the vacuum cleaner of FIG. 1.

FIG. 2B is an end-on view of the insert.

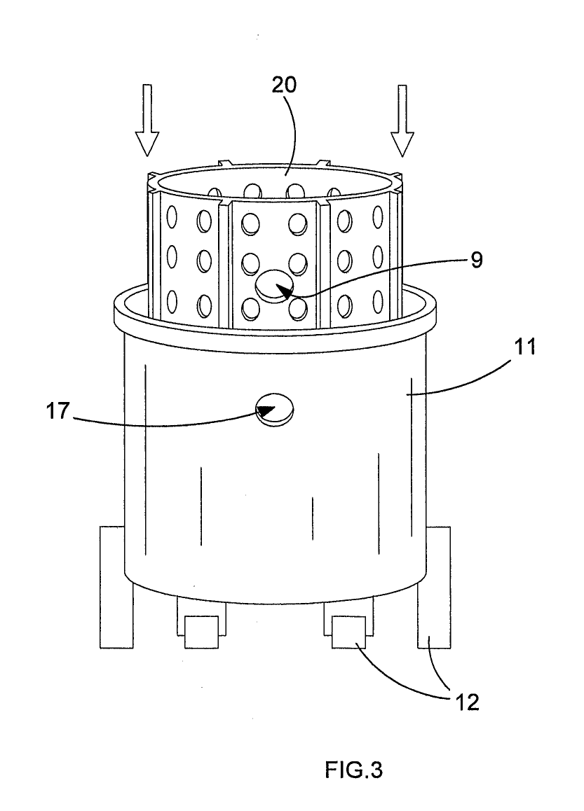

FIG. 3 is a perspective view from one side of the insert during insertion into the chamber.

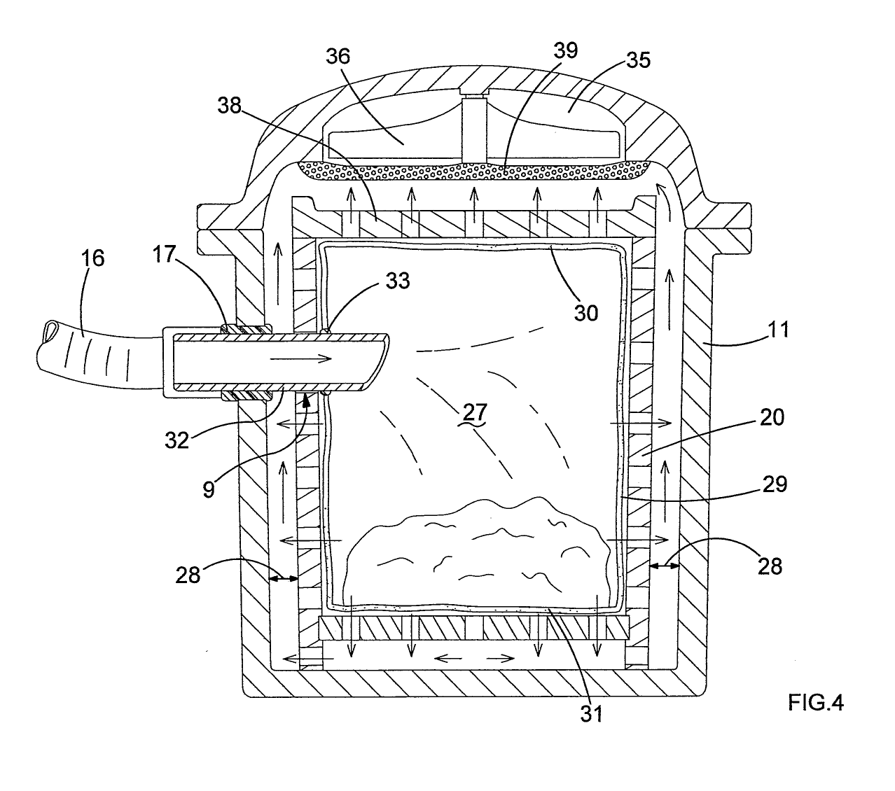

FIG. 4 is a cross-sectional view through the vacuum cleaner.

FIG. 5A is a perspective view of a quarter segment of the insert.

FIG. 5B is an end-on view of a quarter segment, showing a retaining clip attachment to another segment.

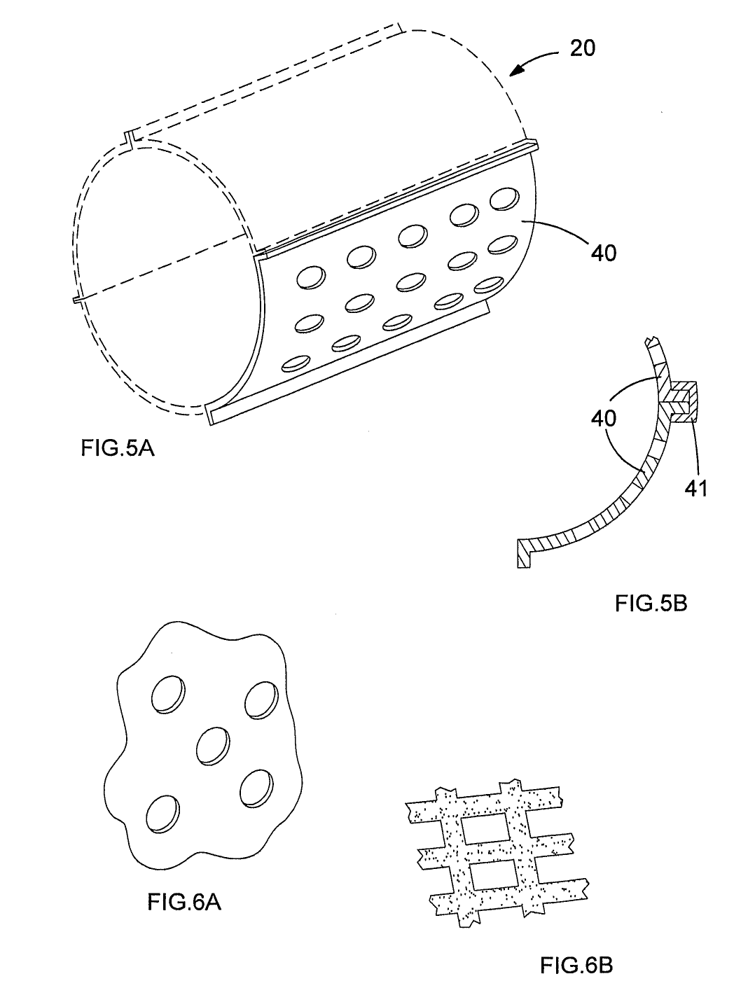

FIG. 6 shows portions of segments each having an alternative arrangement of perforations or mesh.

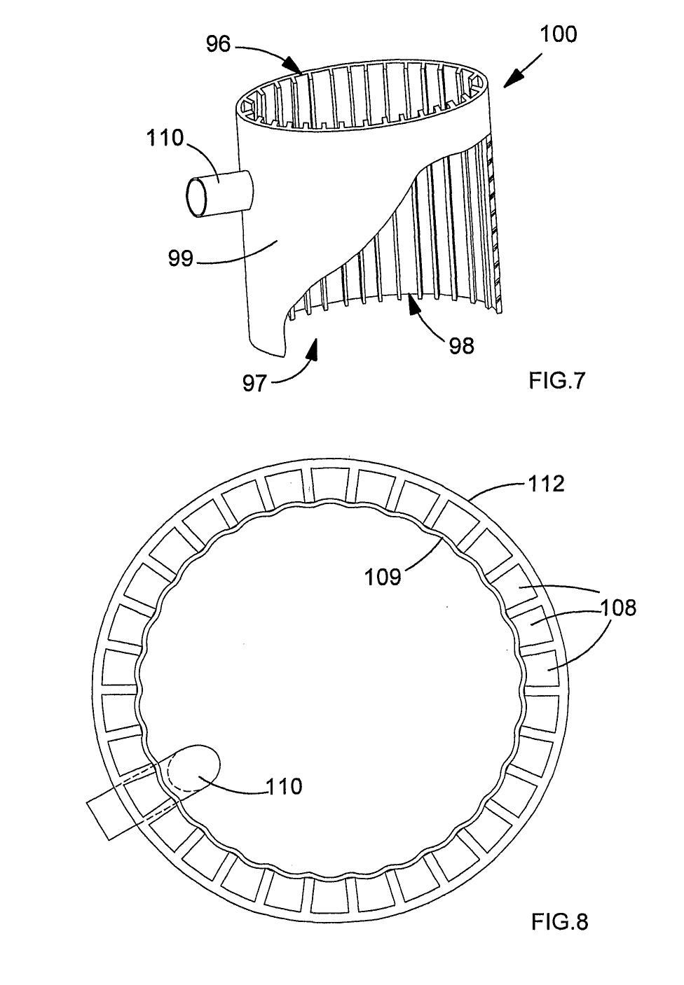

FIG. 7 is a perspective three quarter view, partially cut away of a vacuum cleaner insert according to a second embodiment of the invention.

FIG. 8 is top view of the insert of FIG. 8.

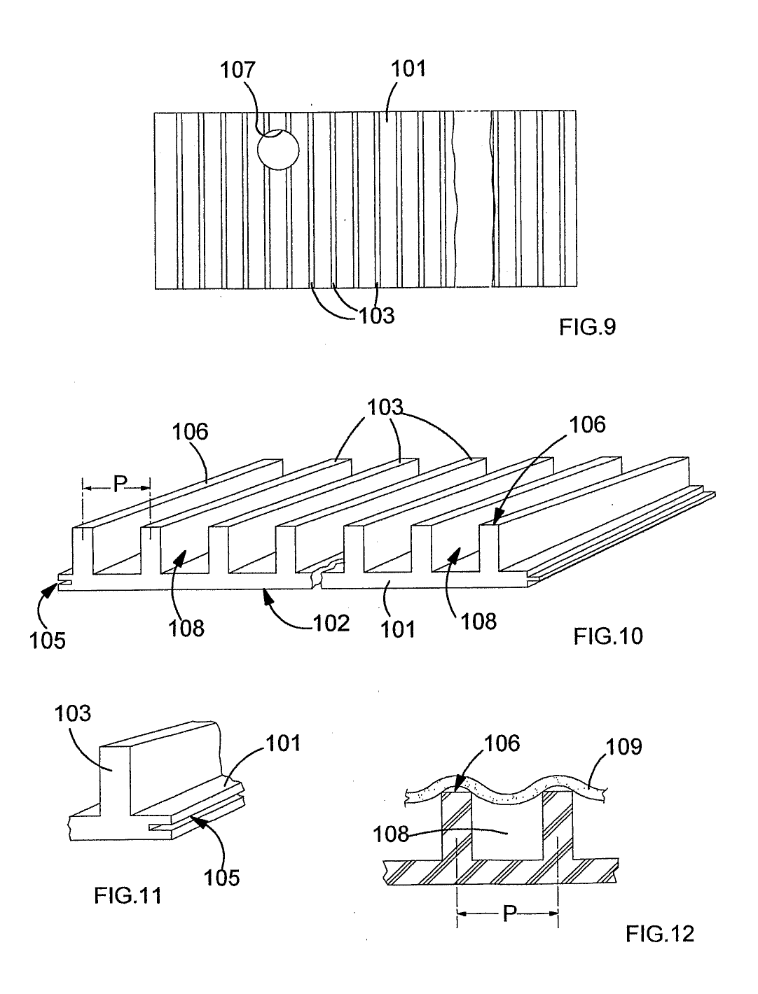

FIG. 9 is a plan view of a sheet if ribbed material used to form the insert.

FIG. 10 is a side view of the sheet of FIG. 9.

FIG. 11 shows detail of end regions of the sheet.

FIG. 12 is a cross sectional view through of a small portion of the sheet.

### FIRST EMBODIMENT

In FIG. 1 a vacuum cleaner is shown generally as 10. The cleaner comprises a drum portion 11 which has a generally cylindrical configuration. A lower end of the drum is supported on wheels 12. A wand portion 13 comprises a rigid tubular handle portion 14 provided at a distal end thereof with a work head 15. The work head is of conventional design, comprising a floor-facing slot aperture with an associated floor brush (not visible in the figure). A flexible hose 16 connects the wand with an inlet port 17 of the drum portion.

A vacuum chamber of the drum portion is provided with an insert 20 shown in FIG. 2A. The insert has a cylindrical sidewall 21 formed of perforated structural plastics material. The circular perforations are shown in a square pattern distribution, but could be hexagonal or other patterns (see FIG. 6A). In another embodiment the wall could be formed of a mesh or lattice (FIG. 6B). A base plate 22 of the insert is formed of the same perforated plastics material. A radially extending ridge 23 is provided on a lower surface of the base plate. A sidewall 21 of the insert is formed with an inlet port 9 (shown in FIG. 3).

The insert is shown end-on in FIG. 2B. Eight longitudinal ridges 24 are formed on the outer surface 25 of the insert. The ridges are circumferentially equally spaced at 0, 45, 90, 135, 180 degree etc separations, as shown in the figure.

A partially obscured perspective view of the insert 20 is shown in FIG. 3. A dirty air inlet port 26 is formed in an upper wall portion of the insert. The insert is placed inside the vacuum chamber 27 by sliding in the direction of the arrows shown in the figure.

The position of the insert in the vacuum chamber is shown in FIG. 4. The insert is a sliding fit in the chamber, with the rib edges abutting the chamber inside wall. The depth of the ridges defines an air gap 28 between the insert and the vacuum chamber inside wall surface.

A porous paper filter bag 29 of generally cylindrical shape is placed inside the insert as shown in FIG. 4. The bag has closed top and bottom ends 30,31. A stub tube 32 extends in a radial direction from the wand hose through the drum inlet port 17, via the insert inlet port and a bag aperture 33 and thence into the bag interior.

An upper end of the insert is closed by a perforated circular lid member 38. Above the lid member, an upper end region of the drum body is provided with an electric suction vacuum fan 36. A fan chamber 35 is separated from the vacuum chamber by an open cell foam filter membrane 39.

In use the vacuum fan draws air via the hose into the bag interior. The filter bag prevents dirt particles (detritus) passing and collects the detritus at a lower end of the bag, which gradually fills. The insert and ridges ensure that an air gap is maintained around the bag and insert. The insert perforations ensure that an air path exists from the bag interior, out of the insert and through the air gap up to the vacuum fan, as indicated by the short arrows in the figure.

This arrangement ensures that the bag, during use, cannot expand to contact the chamber walls. This maintains the suction capability of the bag by ensuring that an air flow path is maintained.

The bag enclosure may be formed by assembling together segments to form the cylinder. As shown in FIG. 5 there are, in this embodiment, four 90 degree segments 40 which are clipped together by compression clamps 41 at abutting ridges.

As the insert is removable from vacuum cleaner a sliding fit it may easily be retrofitted to known drum type vacuum cleaners, providing an increase in suction performance over time. When fine or harmful is dust is no longer to be collected the insert and bag may be removed.

### SECOND EMBODIMENT

In FIG. 7 a further insert according to the invention is shown as 100. The insert has a generally cylindrical, tubular configuration with a side wall 99 formed with a vertically ribbed inner surface 98. The cylinder is open at upper and lower ends 96,97. A vacuum duct 110 passes through the sidewall at an upper region thereof.

The insert is formed of a sheet 101 of ribbed resilient plastics material (e.g. synthetic rubber), as shown in FIGS. 9 and 10. The sheet has a flat underside 102 and an upper surface formed with a plurality of elongate, parallel, upstanding ribs 103. The ribs have a pitch P of 6 to 12 mm, a thickness of 2 to 3 mm and a height of 10 to 15 mm.

The insert is formed by rolling the sheet 101 around the upper surface to form a cylinder, as shown in FIG. 8. Thus the ribs are aligned parallel with the longitudinal axis of the cylinder, and inward facing. At the interface of the sheet ends a tongue and groove 105 connection is made to secure the sheet ends together as a cylinder, detail of which is shown in FIG. 11. Although only a segment of the insert is shown in FIG. 8, the ribs extend around the entire circumference.

The insert is placed inside a tub/drum type vacuum cleaner (see FIG. 1) to form a support for a drum-shaped vacuum cleaner filter bag shown in section in FIG. 8 as 109. The insert is flexible and therefore capable of being fitted into non-circular section machines, for example square or rectangular section machines. The lower surface of the bag fits snugly against the vacuum chamber wall 112, which is of slightly larger diameter than the insert, with a tolerance which permits a snug sliding fit of the insert in the vacuum chamber.

As with the first embodiment, a bag 109 is accommodated inside the insert. The distal ends 106 of the ribs contact the bag outer surface and provide structural support, as well as preventing expansion of the bag against a drum inner wall surface, as shown in FIG. 12. The longitudinal channels 108 formed between ribs provide air flow paths along which air may be drawn to the vacuum drive motor/fan (typically located in an upper portion of the drum/tub cleaner). A rib spacing between adjacent ribs is small enough to prevent the bag bowing out into the channel so as to contact the inner drum wall. A small amount of bag sagging under vacuum suction is inevitable and permissible (as shown in the FIG. 12), but the passages 108 between the ribs should be kept substantially clear to ensure an airflow path in the passages is maintained.

An aperture 107 is formed in the cylinder wall to allow a vacuum duct 110 access through the wall and into the interior of the bag 109, as shown in FIG. 7.

The insert may be retrofitted into pre-existing drum vacuum cleaners, or sold as a component of new machines. It has similar advantages to the insert of the first embodiment, but typically allows for more bag free-surface area through which air may be drawn as contact with the insert is made via rib asperities rather than over an extended surface. The ribs have a further advantage of providing vertical channels through which air may be drawn. This all aids in filtering efficiency.

A vacuum suction drive motor (not shown, but of an arrangement similar to that shown in FIG. 4) is provided at a top region of the vacuum cleaner. The vertical passages 108 provide vertical airflow channels downstream of the filter bag and up to the suction motor, providing a direct flow path.

1. An insert for converting a vacuum cleaner of a type which is configured to operate in a first mode in which air-entrained detritus can be deposited and collected in a vacuum chamber rather than collected in a filter bag through which air is drawn, to a second operative mode in which air-entrained detritus can be collected in a filter bag located in the vacuum chamber,
the insert comprising an enclosure in which the filter bag can be accommodated, which enclosure comprises structural constraint means which limits vacuum induced expansion of at least a region of the bag and maintains an airflow gap between the filter bag outer surface and a vacuum chamber inner wall, wherein the structural constraint means comprises a plurality of spaced apart inward protrusions provided in a base sheet, each protrusion having a base region and a distal end which faces a surface region of the filter bag to limit expansion thereof.

2. (canceled)

3. An insert as claimed in claim 1 wherein the protrusions comprise elongate ribs each having a longitudinal axis which extends parallel to a bag outer surface region and a transverse elongate distal edge which faces the surface region of the bag to limit expansion thereof.

4. An insert as claimed in claim 3 wherein the ribs are oriented generally parallel to each other and define therebetween airflow channels for air drawn through the bag surface and towards a vacuum source.

5. An insert as claimed in claim 1 wherein the base sheet is generally cylindrical in shape and the distal ends or edges of the protrusions project from the inner surface of the base sheet.

6. An insert as claimed in claim 5 wherein the protrusions are a plurality of axially oriented elongate parallel ribs which provide airflow channels in a direction parallel to the cylindrical axis.

7. An insert for converting a vacuum cleaner of a type which is configured to operate in a first mode in which air-entrained detritus can be deposited and collected in a vacuum chamber rather than collected in a filter bag through which air is drawn, to a second operative mode in which air-entrained detritus can be collected in a filter bag located in the vacuum chamber,
the insert comprising an enclosure in which the filter bag can be accommodated, which enclosure comprises a web of material having an inner surface which faces an outer surface region of the filter bag and which limits expansion thereof, and an outer surface which faces the vacuum chamber wall, the web being provided with a plurality of perforations therethrough which provide an airflow path through the enclosure, and wherein the web surface is provided with a plurality of outward protrusions which maintain a spacing between the enclosure outer surface and the vacuum chamber inner wall thereby to provide an airflow gap between the filter bag outer surface and a vacuum chamber inner wall.

8. An insert as claimed in claim 7 wherein the outward protrusions comprise elongate ridges.

9. An insert as claimed in claim 7 wherein the enclosure is generally cylindrical in shape.

10. An insert as claimed in claim 7 wherein the enclosure further comprises a detachable lid plate which provides access to the enclosure interior for placement and removal of a filter bag.

11. An insert as claimed in claim 7 wherein the outward protrusions comprise a plurality of elongate axially extending spacer ribs which serve to space the enclosure wall from the vacuum chamber so as to maintain an airflow gap between the outer surface and the chamber inner wall.

12. An insert as claimed in claim 7 wherein the enclosure is formed from perforated sheet or mesh sheet or lattice work material which remains rigid under vacuum induced bag loading.

13. An insert as claimed in claim 7 wherein the web comprises perforated sheet material, with the area of the perforations being preferably at least 40% of the web area, and most preferably at least 50% of the web area.

14. An insert as claimed in claim 1 wherein a wall portion of the enclosure is formed with an aperture through which a vacuum tube may extend for delivery of air entrained detritus into a filter bag disposed in the enclosure.

15. A vacuum cleaner comprising a vacuum source in fluid communication with a vacuum chamber in which is disposed a filter bag for collecting detritus, the vacuum source being arranged, in use, to draw detritus-laden air into the bag, wherein a removable insert is provided in the vacuum chamber and in which insert the bag is accommodated
the insert comprising an enclosure in which the filter bag can be accommodated, which enclosure comprises structural constraint means which limits vacuum induced expansion of at least a region of the bag and maintains an airflow gap between the filter bag outer surface and a vacuum chamber inner wall wherein the structural constraint means comprises a plurality of spaced apart protrusions provided in a base sheet, each protrusion having a base region and a distal end which faces a surface region of the filter bag to limit expansion thereof in one or more directions so that a minimum spacing between a surface portion of the bag and a wall portion of the vacuum chamber bag is maintained, the spacing providing an air gap through which air may be drawn towards the vacuum source.

16. A vacuum cleaner as claimed in claim 15 wherein the vacuum chamber has a cylindrical shape.

17. A vacuum cleaner as claimed in claim 15 wherein the insert is centrally disposed in the vacuum chamber.

18. A vacuum cleaner as claimed in claim 15 wherein the filter bag is generally drum shaped and formed with an aperture which aligns with an aperture in the enclosure.

19. A vacuum cleaner as claimed in claim 15 which is of a type having a vacuum wand portion, the wand portion being provided with a distal end region for lifting detritus from a surface to be cleaned and comprising a fluid flow path for conveying detritus to the vacuum chamber.

20. A vacuum cleaner as claimed in claim 19 which is of a type having a lower portion which comprises a vacuum chamber and an upper portion in which is located a suction motor for drawing air into the vacuum chamber via the wand portion.

21. A vacuum cleaner as claimed in claim 20 wherein the upper portion is detachable from, or may be flipped with respect to the collection bin so as to facilitate access to the vacuum chamber for emptying of the bin or removal of the insert.

22. (canceled)

23. A vacuum cleaner as claimed in claim 15 wherein the insert is of a size and configuration which provides a sliding fit in the vacuum chamber.

24. A method of converting a vacuum cleaner of a type which is configured to operate in a first mode in which air-entrained detritus can be deposited and collected in a vacuum chamber rather than collected in a filter bag through which air is drawn, to a second operative mode in which air-entrained detritus is collected in a filter bag located in the vacuum chamber, the method comprising:
providing an insert according to claim 1,
opening the vacuum chamber,
placing the insert in the vacuum chamber, and
locating a filter bag in the enclosure provided by the insert.

25. A method as claimed in claim 24 wherein the insert is of a size and configuration which provides a sliding fit in the vacuum chamber.

26. An insert as claimed in claim 7 wherein a wall portion of the enclosure is formed with an aperture through which a vacuum tube may extend for delivery of air entrained detritus into a filter bag disposed in the enclosure.

27. A vacuum cleaner comprising a vacuum source in fluid communication with a vacuum chamber in which is disposed a filter bag for collecting detritus, the vacuum source being arranged, in use, to draw detritus-laden air into the bag, wherein removable insert is provided in the vacuum chamber and in which insert the bag is accommodated,
the insert comprising an enclosure in which the filter bag can be accommodated, which enclosure comprises a web of material having an inner surface which faces an outer surface region of the filter bag and which limits vacuum induced expansion of at least a region of the bag thereof, and an outer surface which faces the vacuum chamber wall, the web being provided with a plurality of perforations therethrough which provide an airflow path through the enclosure, and wherein the web outer surface is provided with a plurality of outward protrusions which maintain a minimum spacing between the enclosure outer surface and the vacuum chamber inner wall so as to provide an airflow gap between the filter bag outer surface and a vacuum chamber inner wall.

28. A vacuum cleaner as claimed in claim 27 wherein the outward protrusions comprise elongate ridges.

29. A vacuum cleaner as claimed in claim 27 wherein the vacuum chamber has a cylindrical shape.

30. A vacuum cleaner as claimed in claim 27 wherein the insert is centrally disposed in the vacuum chamber.

31. A vacuum cleaner as claimed in claim 27 wherein the filter bag is generally drum shaped and formed with an aperture which aligns with an aperture in the enclosure.

32. A vacuum cleaner as claimed in claim 27 which is of a type having a vacuum wand portion, the wand portion being provided with a distal end region for lifting detritus from a surface to be cleaned and comprising a fluid flow path for conveying detritus to the vacuum chamber.

33. A vacuum cleaner as claimed in claim 32 which is of a type having a lower portion which comprises a vacuum chamber and an upper portion in which is located a suction motor for drawing air into the vacuum chamber via the wand portion.

34. A vacuum cleaner as claimed in claim 33 wherein the upper portion is detachable from, or may be flipped with respect to, the collection bin so as to facilitate access to the vacuum chamber for emptying of the bin or removal of the insert.

35. A vacuum cleaner as claimed in claim 27 wherein the insert is of a size and configuration which provides a sliding fit in the vacuum chamber.

36. A method of converting a vacuum cleaner of a type which is configured to operate in a first mode in which air-entrained detritus can be deposited and collected in a vacuum chamber rather than collected in a filter bag through which air is drawn, to a second operative mode in which air-entrained detritus is collected in a filter bag located in the vacuum chamber, the method comprising:
providing an insert according to claim 7,
opening the vacuum chamber,
placing the insert in the vacuum chamber, and
locating a filter bag in the enclosure provided by the insert.

37. A method as claimed in claim 36 wherein the insert is of a size and configuration which provides a sliding fit in the vacuum chamber.
